(19) United States
(12) Patent Application Publication
(10) Pub. No.: US 2025/0317296 A1
(43) Pub. Date: Oct. 9, 2025

(54) PIECEWISE GENERATION AND TRANSMISSION OF AUTHENTICATION TOKENS

(71) Applicant: Microsoft Technology Licensing, LLC, Redmond, WA (US)

(72) Inventor: Emilian-Mircea MIEILICA, Prague (CZ)

(73) Assignee: Microsoft Technology Licensing, LLC, Redmond, WA (US)

(21) Appl. No.: 18/630,658

(22) Filed: Apr. 9, 2024

(51) Int. Cl. H04L 9/32

(52) U.S. Cl. CPC H04L 9/3213; H04L 9/3247

(57) ABSTRACT

Techniques are described for piecewise generation and transmission of authentication tokens in a collaboration environment. A sender system associated with a user of a collaboration platform intending to send a communication to multiple recipients can request authentication tokens for the recipients from an authorization service. The authorization service can generate and transmit to the sender system a base token, which applies to multiple communication recipients, and a respective authentication delta for each recipient. The base token can be signed or unsigned. Each authentication delta can include recipient-specific data such as a payload claim serving as an immutable identifier of the recipient and a unique signature for the recipient. The sender system can then assemble an authentication token for each recipient by combining the base token with the appropriate authentication delta. Optionally, transformation delta(s) can be used to alter the authentication tokens on a per-user basis.

### BACKGROUND

Authentication tokens issued by an authority can be used to validate communications sent among participants of a collaboration platform. When a participant (“sender”) sends a communication to other participants (“recipients”) of the collaboration platform, the sender also sends an authentication token to each of the recipients' systems, which can include multiple sub-systems (e.g., instant messaging, email, audio calling, and video conferencing) that control the recipient's data. The authentication token received from the sender of a communication can be used by each sub-system of the recipient's system to validate that the communication is intended for the recipient.

Some collaboration platforms use JavaScript Object Notation (JSON) web tokens (JWTs) as authentication tokens. A JWT typically includes a header, a payload including claims, and a signature; the payload claims can include a claim identifying a recipient. The data stored in a JWTs can be encoded (e.g., using Base64 encoding) for compactness. JWTs are often signed using the Hash-based Message Authentication Code (HMAC) technique, which uses a cryptographic hash function in combination with a secret key. In such examples, the header and payload of a JWT is combined with a secret key; the result is hashed to produce a unique hash value (i.e., the HMAC), which serves as a signature for the JWT.

### SUMMARY

In summary, the detailed description presents innovations in piecewise generation and transmission of authentication tokens in a collaboration environment. A user of a collaboration platform acting a sender can request authentication tokens for multiple users of the collaboration platform who are the intended recipients of one or more communications (e.g., messages or commands) to be sent by the sender. An authority, such as an authorization service, can generate authentication deltas for each of the intended recipients as well as a base token. The base token includes header and payload data (e.g., claims), and can have either no signature or a signature of just the content of the base token. The authentication delta for a given recipient includes a claim representing an immutable identifier of the recipient, a signature, and optionally other claims. Upon receipt of the base token and authentication deltas, the sender can assemble authentication tokens for the recipients by combining the base token with the respective authentication deltas. The sender can then transmit the authentication tokens to the appropriate recipients along with the communications, thereby validating the communications. In some examples, the authority also generates transformation deltas which can be used to alter claims of the base token during assembly of an authentication tokens.

The innovations described herein can be implemented as part of a method, as part of a computing system (physical or virtual, as described below) configured to perform the method, or as part of a tangible computer-readable media storing computer-executable instructions for causing one or more processors, when programmed thereby, to perform the method. The various innovations can be used in combination or separately. The innovations described herein include the innovations covered by the claims. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures and illustrates a number of examples. Examples may also be capable of other and different applications, and some details may be modified in various respects all without departing from the spirit and scope of the disclosed innovations.

### BRIEF DESCRIPTION OF THE DRAWINGS

The following drawings illustrate some features of the disclosed innovations.

FIG. 1 is a diagram illustrating an example computing system in which some described embodiments can be implemented.

FIG. 2 is a diagram of an example network environment in which some described embodiments can be implemented.

FIG. 3 is a diagram of an example processing flow for piecewise generation and transmission of authentication tokens.

FIG. 4 is a diagram of example objects including an unsigned base token, a signed base token, authentication deltas, and authentication tokens.

FIG. 5 is a diagram of example objects including an unsigned base token, an authentication delta, a transformation delta, and an altered authentication token.

FIGS. 6-8 are flowcharts illustrating generalized techniques for piecewise generation and transmission of authentication tokens in accordance with some of the described embodiments.

### DETAILED DESCRIPTION

The detailed description presents innovations in piecewise generation and transmission of authentication tokens in a collaboration environment. These innovations can reduce the extent to which a participant of a collaboration platform must interact with an authority to obtain authentication tokens to validate communications sent to other participants of the collaboration platform, as well as the processing cost associated with such interactions.

The technologies described herein provide technical solutions to the technical problems associated with generation and transmission of authentication tokens. One such technical problem involves the processing cost of the transactions carried out between a collaboration platform participant and an authority (e.g., an authorization service hosted on a computer system) in order for the participant to send a communication to multiple other participants of the collaboration platform. Typically, the sender obtains a unique authentication token from the authority for each intended recipient of the communication in order to validate the communication (e.g., to confirm the communication has been sent to the correct recipient). In order for the sender to perform an operation such as sending an instant message to several recipients, the sender's computer system performs a separate transaction with the authority for each recipient in which a request for an authentication token for the recipient is sent to and fulfilled by the authority. Although the authentication tokens for multiple recipients often include much of the same content, each authentication token has a claim which identifies the recipient and other optional claims as well as a unique signature (e.g., an HMAC signature generated by performing a hash function on the other contents of the authentication token, including the claim identifying the recipient and the optional claims if present).

Technical solutions to these problems provided by the technologies disclosed herein include methods and systems for piecewise generation and transmission of authentication tokens. In accordance with the technologies disclosed herein, an authority can generate a signed or unsigned base token, which applies to multiple communication recipients, along with a respective authentication delta for each recipient. The base token can include, for example, header data that is generic to all the intended recipients of the communication, whereas each authentication delta can include recipient-specific data such as a payload claim serving as an immutable identifier of the recipient and a unique signature for the recipient, among other data. The computer system of the sender (“sender system”) can then assemble an authentication token for each recipient by combining the base token with the appropriate authentication delta. Accordingly, the technologies disclosed herein provide technical advantages, such as a reduction in the processing cost of obtaining authentication tokens for communications sent among participants of a collaboration platform. In particular, the amount of data that is typically sent from an authorization service to a sender system to provide the sender system with authentication tokens for intended recipients of a communication is reduced by eliminating redundancy that is typically present in such transactions (e.g., due to transmission of entire authentication tokens which share common values of many fields and/or claims).

Additional technical advantages provided by the technologies disclosed herein include enhanced flexibility and control for senders of communications. For example, some described embodiments involve the authorization service generating transformation deltas which include alternative value(s) of authentication token claims. During assembly of an authentication token for a given recipient, the sender system can opt to alter some of the data of the base token (e.g., the values of one or more of the payload claims of the base token). As an illustrative example, the base token can have a scope claim with a value that dictates the degree of control the recipient will have over the communication (e.g., a value dictating that the recipient will have read-only access to the communication). A transformation delta issued by the authorization service can include a scope claim with a different value than the scope claim of the base token (e.g., a value dictating that the recipient will have write access to the communication). When assembling the authentication token for a given recipient, the sender system can opt to include either the original value of the scope claim from the unsigned base token or the altered value of the scope claim from the transformation delta. Accordingly, the technologies disclosed herein provide the technical advantage of enhanced flexibility and control for senders of the communications (e.g., control of how communications will be handled on a per-recipient basis).

In the examples described herein, identical reference numbers in different figures indicate an identical component, module, or operation. More generally, various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Some of the innovations described herein address one or more of the problems noted in the background. Typically, a given technique/tool does not solve all such problems. It is to be understood that other examples may be utilized and that structural, logical, software, hardware, and electrical changes may be made without departing from the scope of the disclosure. The following description is, therefore, not to be taken in a limited sense.

### I. EXAMPLE COMPUTER SYSTEMS

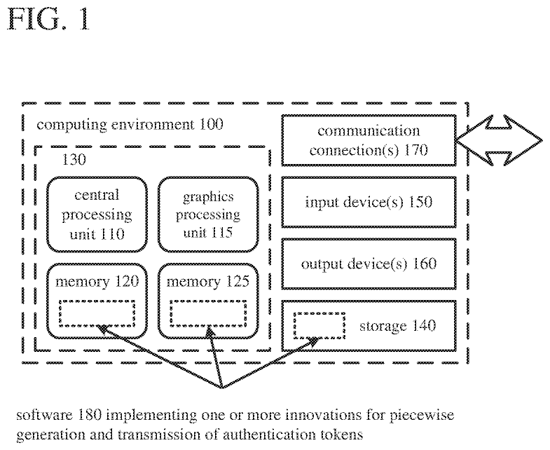

FIG. 1 illustrates a generalized example of a suitable computer system (100) in which several of the described innovations may be implemented. The innovations described herein relate to piecewise generation and transmission of authentication tokens in a collaboration environment. The computer system (100) is not intended to suggest any limitation as to scope of use or functionality, as the innovations may be implemented in diverse computer systems, including special-purpose computer systems.

With reference to FIG. 1, the computer system (100) includes one or more processing units (110, 115) and memory (120, 125). The processing units (110, 115) execute computer-executable instructions. A processing unit can be a general-purpose central processing unit (“CPU”), processor in an application-specific integrated circuit (“ASIC”) or any other type of processor. In a multi-processing system, multiple processing units execute computer-executable instructions to increase processing power. For example, FIG. 1 shows a CPU (110) as well as a graphics processing unit (“GPU”) (115). In general, the GPU (115) is any specialized circuit, different from the CPU (110), that accelerates creation and/or manipulation of image data in a graphics pipeline. The GPU (115) can be implemented as part of a dedicated graphics card (video card), as part of a motherboard, as part of a system on a chip (“SoC”), or in some other way (even on the same die as the CPU (110)).

The tangible memory (120, 125) may be volatile memory (e.g., registers, cache, RAM), non-volatile memory (e.g., ROM, EEPROM, flash memory, etc.), or some combination of the two, accessible by the processing unit(s). The memory (120, 125) stores software (180) implementing one or more innovations for . . . , in the form of computer-executable instructions suitable for execution by the processing unit(s).

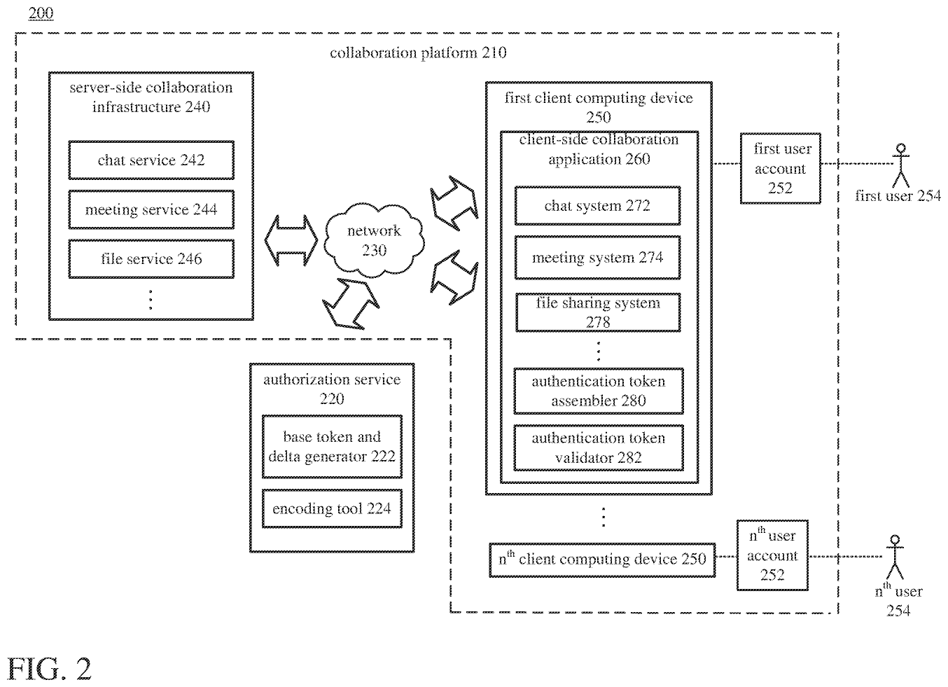

In some examples, software (180) includes a collaboration platform (e.g., a collaboration software suite) which facilitates collaborative communication among participants in a network environment. An example collaboration platform is described further herein with reference to FIG. 2.

A computer system may have additional features. For example, the computer system (100) includes storage (140), one or more input devices (150), one or more output devices (160), and one or more communication connections (170). An interconnection mechanism (not shown) such as a bus, controller, or network interconnects the components of the computer system (100). Typically, operating system (“OS”) software (not shown) provides an operating environment for other software executing in the computer system (100), and coordinates activities of the components of the computer system (100).

The tangible storage (140) may be removable or non-removable, and includes magnetic storage media such as magnetic disks, magnetic tapes or cassettes, optical storage media such as CD-ROMs or DVDs, or any other medium which can be used to store information and which can be accessed within the computer system (100). The storage (140) can store instructions for the software (180) implementing one or more innovations for piecewise generation and transmission of authentication tokens.

The input device(s) (150) may be a touch input device such as a keyboard, mouse, pen, or trackball, a voice input device, a scanning device, or another device that provides input to the computer system (100). For video, the input device(s) (150) may be a camera, video card, screen capture module, TV tuner card, or similar device that accepts video input in analog or digital form, or a CD-ROM or CD-RW that reads video input into the computer system (100). The output device(s) (160) may be a display, printer, speaker, CD-writer, or another device that provides output from the computer system (100).

The communication connection(s) (170) enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-readable media. Computer-readable media are any available tangible media that can be accessed within a computing environment. By way of example, and not limitation, with the computer system (100), computer-readable media include memory (120, 125), storage (140), and combinations thereof. As used herein, the term computer-readable media does not include transitory signals or propagating carrier waves.

The innovations can be described in the general context of computer-executable instructions, such as those included in program modules, being executed in a computer system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computer system.

The terms “system” and “device” are used interchangeably herein. Unless the context clearly indicates otherwise, neither term implies any limitation on a type of computer system or computer device. In general, a computer system or computer device can be local or distributed, and can include any combination of special-purpose hardware and/or general-purpose hardware with software implementing the functionality described herein.

For the sake of presentation, the detailed description uses terms like “determine” and “perform” to describe computer operations in a computer system. These terms are high-level abstractions for operations performed by a computer, and should not be confused with acts performed by a human being. The actual computer operations corresponding to these terms vary depending on implementation.

When an ordinal number (such as “first,” “second,” “third” and so on) is used as an adjective before a term, that ordinal number is used (unless expressly specified otherwise) merely to indicate a particular feature, such as to distinguish that particular feature from another feature that is described by the same term or by a similar term. The mere usage of the ordinal numbers “first,” “second,” “third,” and so on does not indicate any physical order or location, any ordering in time, or any ranking in importance, quality, or otherwise. In addition, the mere usage of ordinal numbers does not define a numerical limit to the features identified with the ordinal numbers.

When introducing elements, the articles “a,” “an,” “the,” and “said” are intended to mean that there are one or more of the elements. The terms “comprising,” including,” and “having” are intended to be inclusive and mean that there may be additional elements other than the listed elements.

When a single device, component, module, or structure is described, multiple devices, components, modules, or structures (whether or not they cooperate) may instead be used in place of the single device, component, module, or structure. Functionality that is described as being possessed by a single device may instead be possessed by multiple devices, whether or not they cooperate. Similarly, where multiple devices, components, modules, or structures are described herein, whether or not they cooperate, a single device, component, module, or structure may instead be used in place of the multiple devices, components, modules, or structures. Functionality that is described as being possessed by multiple devices may instead be possessed by a single device. In general, a computer system or device can be local or distributed, and can include any combination of special-purpose hardware and/or hardware with software implementing the functionality described herein.

Further, the techniques and tools described herein are not limited to the specific examples described herein. Rather, the respective techniques and tools may be utilized independently and separately from other techniques and tools described herein.

Device, components, modules, or structures that are in communication with each other need not be in continuous communication with each other, unless expressly specified otherwise. On the contrary, such devices, components, modules, or structures need only transmit to each other as necessary or desirable, and may actually refrain from exchanging data most of the time. For example, a device in communication with another device via the Internet might not transmit data to the other device for weeks at a time. In addition, devices, components, modules, or structures that are in communication with each other may communicate directly or indirectly through one or more intermediaries.

As used herein, the term “send” denotes any way of conveying information from one device, component, module, or structure to another device, component, module, or structure. The term “receive” denotes any way of getting information at one device, component, module, or structure from another device, component, module, or structure. The devices, components, modules, or structures can be part of the same computer system or different computer systems. Information can be passed by value (e.g., as a parameter of a message or function call) or passed by reference (e.g., in a buffer). Depending on context, information can be communicated directly or be conveyed through one or more intermediate devices, components, modules, or structures. As used herein, the term “connected” denotes an operable communication link between devices, components, modules, or structures, which can be part of the same computer system or different computer systems. The operable communication link can be a wired or wireless network connection, which can be direct or pass through one or more intermediaries (e.g., of a network).

A description of an example with several features does not imply that all or even any of such features are required. On the contrary, a variety of optional features are described to illustrate the wide variety of possible examples of the innovations described herein. Unless otherwise specified explicitly, no feature is essential or required.

Further, although process steps and stages may be described in a sequential order, such processes may be configured to work in different orders. Description of a specific sequence or order does not necessarily indicate a requirement that the steps/stages be performed in that order. Steps or stages may be performed in any order practical. Further, some steps or stages may be performed simultaneously despite being described or implied as occurring non-simultaneously. Description of a process as including multiple steps or stages does not imply that all, or even any, of the steps or stages are essential or required. Various other examples may omit some or all of the described steps or stages. Unless otherwise specified explicitly, no step or stage is essential or required. Similarly, although a product may be described as including multiple aspects, qualities, or characteristics, that does not mean that all of them are essential or required. Various other examples may omit some or all of the aspects, qualities, or characteristics.

An enumerated list of items does not imply that any or all of the items are mutually exclusive, unless expressly specified otherwise. Likewise, an enumerated list of items does not imply that any or all of the items are comprehensive of any category, unless expressly specified otherwise.

### II. EXAMPLE NETWORK ENVIRONMENT

FIG. 2 shows an example network environment (200) that includes a collaboration platform (210) and an authorization service (220). Collaboration platform (210) and the components thereof connect with authorization service (220) over a network (230) such as the Internet or another computer network, using an appropriate communication protocol. The components of collaboration platform (210), such as server-side collaboration infrastructure (240) and client computing devices (250), can also connect with one another over the network (230) using an appropriate communication protocol.

Collaboration platform (210) includes server-side collaboration infrastructure (240), which can include software and/or hardware resources (e.g., computer servers, cloud computing resources, software resources, etc.). In the depicted example, server-side collaboration infrastructure (240) includes a chat service (242), a meeting service (244), and a file service (246), among other services. Chat service (242) can facilitate real-time text messaging among users participating in the collaboration platform, e.g., by handling message delivery chat history, and notifications. Meeting service (244) can manage online meetings conducted via the collaboration platform (210), which can include video conferences and phone calls. Towards this end, meeting service (244) can facilitate scheduling of online meetings, joining of online meetings, screen sharing, and recording. File service (246) can enable storing of files, sharing of files, and collaboration on files for users participating in the collaboration platform (210).

Each client computing device (250) of collaboration platform (210) can be associated with a user account of a user that participates in (e.g., subscribes to) the collaboration platform (210). In the depicted example, a first client computing device (250) is associated with a first user account (252) for a first user (254), whereas an n^{th} client computing device (250) is associated with an n^{th} user account (252) for an n^{th} user (254); n can represent any number greater than or equal to 2. The client computing devices (250) can include, among other devices, desktop computers, laptop computers, tablets, and smart phones.

A client-side collaboration application (260) executes on each of the client computing devices (250). Client-side collaboration application (260) can include a plurality of subsystems (e.g., software modules) which perform the various functions of the collaboration platform (210). In the depicted example, a client-side collaboration application (260) executing on the first client computing device (250) includes a chat system (272), a meeting system (274), a file sharing system (278), an authentication token assembler (280), and an authentication token validator (282), among other subsystems. Chat system (272) provides text-based messaging functionality, meeting service (244) provides online meeting functionality (e.g., video conferences and phone calls), and file sharing system (278) provides file storage, sharing and collaboration functionality for the user of client-side collaboration application (260).

The authentication token assembler (280) subsystem can perform operations for assembling authentication tokens out of base tokens and deltas received from the authorization service (220). As described herein, when the user associated with the client-side collaboration application (260) is acting as a sender of a communication to other users of the collaboration platform (210), the user can obtain a base token from the authorization service (220), along with an authentication delta for each intended recipient of the communication. The authentication token assembler (280) can then assemble respective authentication tokens for the intended recipients by combining, for each intended recipient, the base token with the appropriate authentication delta.

Alternatively, in some examples, the original sender of a communication can forward the communication along with a base token and a plurality of authentication deltas to a recipient service which acts as an intermediary between the sender and the intended recipients. In such examples, the recipient service can include an authentication token assembler (280) in order to assemble authentication tokens for a plurality of recipients. The recipient service can then transmit authentication tokens to the intended recipients, e.g., in batches.

The authentication token validator (282) subsystem can perform operations for validating a communication received from another user of the collaboration platform (210) using the authentication token received along with the communication. For example, when the user associated with the client-side collaboration application (260) is acting as a recipient of a communication from another user of the collaboration platform (210), the authentication token validator (282) can perform operations to validate the received communication using the authentication token (e.g., by processing the signature of the authentication token).

Authorization service (220) can include software and/or hardware resources (e.g., computer servers, cloud computing resources, software resources, etc.) configured to generate base tokens, authentication deltas, and transformation deltas. In some examples, the authorization service (220) is also an authentication service which handles authentication of users (e.g., users of the collaboration platform (210). In the depicted example, authorization service (220) is external to (e.g., not part of) collaboration platform (210). However, in other examples, authorization service (220) can be an integral part of the collaboration platform (210) (e.g., part of server-side collaboration infrastructure (240)).

In the depicted example, authorization service (220) includes a base token and delta generator (222) and an encoding tool (224). The base token and delta generator (222) and the encoding tool (224) can be implemented using software modules, for example. When a client-side collaboration application (260) receives an indication that the associated user has initiated a communication to a plurality of other users of the collaboration platform (210), e.g., via user input to a user interface of the associated client computing device (250), the client-side collaboration application (260) can transmit a request to the authorization service (220) for authentication tokens for the intended recipients of the communication. Responsive to the request, the base token and delta generator (222) can perform operations to generate a base token (e.g., a signed base token or an unsigned base token), as well as to generate respective authentication deltas for each intended recipient. Optionally, the base token and delta generator (222) can also perform operations to generate transformation deltas which can be used during assembly of an authentication token to alter the value of a claim of the base token.

As shown, authorization service (220) can also include an encoding tool (224). Encoding tool (224), which can be implemented using a software module, can perform operations to encode the base tokens and deltas generated by the base token and delta generator (222). For example, the encoding tool (224) can encode data representing the base tokens and deltas using the Base64 encoding method. Base64 encoding involves encoding binary data into a text-based format that is ASCII-readable by converting the binary data into a set of 64 characters including letters, digits, and special characters. Alternatively, the encoding tool (224) can encode the data using other encoding methods. Due to the encoding of the data therein, the authentication tokens generated by the techniques disclosed herein are sometimes referred to as “compressed” authentication tokens.

### III. EXAMPLE PROCESSING FLOWS FOR PIECEWISE GENERATION AND TRANSMISSION OF AUTHENTICATION TOKENS

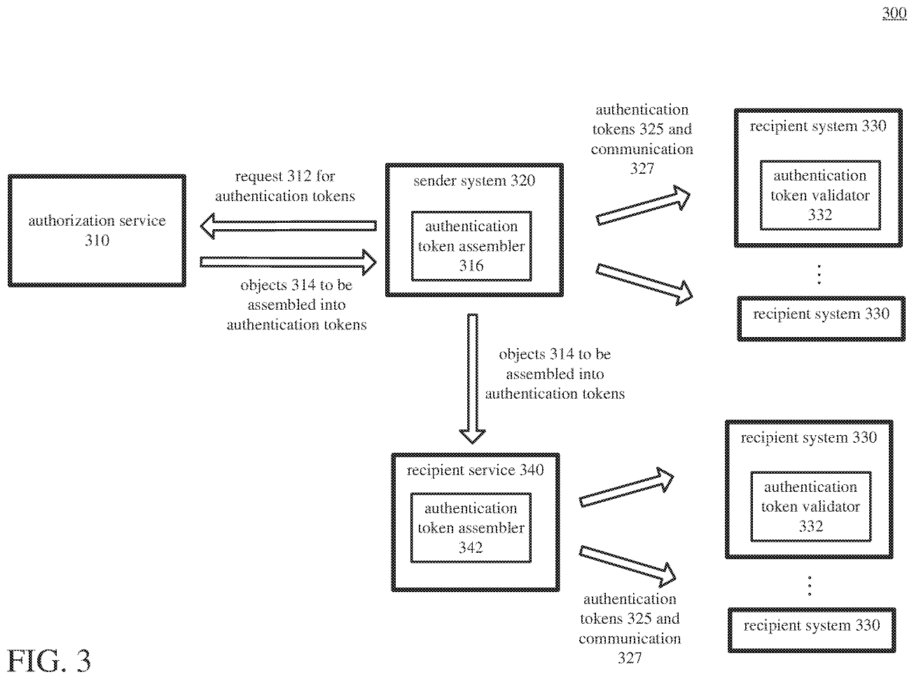

FIG. 3 shows an example processing flow (300) for piecewise generation and transmission of authentication tokens in the context of a collaboration platform. The processing flow (300) involves an authorization service (310), a sender system (320), a plurality of recipient systems (330), and a recipient service (340).

The authorization service (310) is configured to receive requests for authentication tokens from participants of a collaboration platform, or from other entities. In the depicted example, a request (312) for authentication tokens is sent from sender system (320) to authorization service (310). Authorization service (310) can correspond to authorization service (220) of FIG. 2, and thus can include means for generating and encoding base tokens and deltas, such as an encoding tool and a base token and delta generator. Sender system can correspond to one of the client computing devices (250) shown in FIG. 2, and thus can be a client computing device hosting a client-side collaboration platform include a plurality of systems along with means for assembling authentication tokens, such as the depicted authentication token assembler (316). The sender system (320) can send the request (312) in response to an indication that a user of the collaboration platform associated with the sender system (320) has initiated a communication (327) to a plurality of other users of the collaboration platform. The communication (327) can include a message (e.g., a text-based chat message) or a command, for example. The communication (327) can have any machine-readable format, such as a JSON object or eXtensible Markup Language (XML) object.

In response to the request (312), the authorization service (310) transmits objects (314) to be assembled into authentication tokens to sender system (320). The objects (314) can include a base token, one or more authentication deltas, and optionally, one or more transformation deltas. Each of the objects can be a JSON object comprising an unordered collection of key-value pairs. In such examples, the keys can be strings, whereas the values can be strings, numbers, arrays, other objects, Boolean values, or null. Alternatively, the objects can have a format other than JSON. The object data (e.g., the key-value pairs within the objects) can be encoded by the authorization service (310), e.g., using Base64 encoding or another encoding technique.

The sender system (320) then assembles the objects (314) into authentication tokens. This can include the sender system (320) generating the requested quantity of “blank” authentication tokens, which will be referred to herein as templates, or fetching a template from memory and duplicating it to obtain templates for the requested quantity of authentication tokens. Each template can include an empty header object, an empty payload object, and an empty signature object. The sender system (320) can then assemble the objects (314) into authentication tokens by populating the header, payload, and signature objects of each template with data from the base token, and optionally, with data from one or more other objects (314) such an authentication delta and/or a transformation delta. For example, if the base token is unsigned, assembling the objects (314) into authentication tokens can include populating the signature object of each template with a signature from either an authentication delta or a transformation delta. Or, if the base token is signed, assembling the objects (314) into authentication tokens can include replacing the signature of the signed base token with a signature from either an authentication delta or a transformation delta.

Alternatively, assembly of the objects (314) into an authentication token for a given user can include modifying the base token to include data extracted from the authentication delta for the user, e.g., modifying the payload object of the base token to include any payload claim(s) in the authentication delta for the user and either adding the signature extracted from the authentication delta for the user to the signature object of the base token (for an unsigned base token) or replacing the signature object of the base token with a signature extracted from the authentication delta for the user (for a signed base token). In other examples, assembly of the objects (314) into an authentication token for a given user can include modifying the base token to include data extracted from one or more transformation deltas, e.g., modifying the payload object of the base token to include payload claim(s) from one or more transformation delta(s) and either adding the signature extracted from a transformation delta to the signature object of the base token (for an unsigned base token) or replacing the signature object of the base token with a signature extracted from a transformation delta (for a signed base token)

The header object of each template can be populated with key-value pairs from the base token received from the authorization service (310). In an example where the authentication token being generated is a JWT, the key-value pairs from the header object (referred to as fields) used to populate the header of the template can include an algorithm field (“alg”) and a type field (“typ”), among other fields. The value of the “alg” field specifies the cryptographic algorithm used to secure the JWT, and thus indicates how the signature was computed. Some examples of “alg” field values include “HS256”, indicating that HMAC using Secure Hash Algorithm (SHA) 256-bit was used by the authorization service (310) to compute the signature; “RS256”, indicating that the Rivest-Shamir-Adleman (RSA) encryption algorithm using SHA-256 was used to compute the signature; and “ES256”, indicating that the Elliptic Curve Digital Signature Algorithm using SHA-256 was used to compute the signature. The value of the “typ” field specifies the type of the token, which would be JWT in this example.

The payload object of each template can be populated with key-value pairs from one of the authentication deltas, and optionally, with key-value pairs from a transformation delta. In an example where the authentication token being generated is a JWT, the key-value pairs from the payload object (referred to as claims) used to populate the payload of the template can include an issuer claim (“iss”) whose value specifies the issuer of the authentication token (e.g., the authorization service (310); an expiration time claim (“exp”) whose value is a future timestamp for a time at which the authentication token will expire; an object immutable identifier claim (“oid”) whose value serves as an immutable identifier of the user (e.g., user account) associated with the authentication token; and a scope claim (“scp”) whose value specifies the scope of access granted to the JWT bearer (e.g., the user associated with the authentication token), among other claims.

The signature object of each template can be populated with the data from the signature object received from the authorization service (310). This data can include an encoded string of characters generated by the authorization service (310) using a cryptographic algorithm (e.g., the cryptographic algorithm specified in the “alg” field of the header object). In examples where the HMAC cryptographic algorithm is used, the signature can be the result of a hash function executed on other claims and/or fields that will be included in the authentication token (e.g., a hash function executed on the “oid” claim for the user associated with the authentication token).

In examples where the transformation delta(s) are provided by the authorization service (310), the sender system (320) can opt to modify the values of one or more payload claims in the assembled authentication tokens, on a per-user or per-subset-of-users basis. For example, the sender system (320) can opt to grant a narrower scope of access to a subset of the users who will be receiving respective authentication tokens than the scope specified in the base token or authentication deltas. In this example, the sender system (320) can request a transformation delta from the authorization service (310) including data representing one or more “scp” claims with values specifying the desired narrower scope of access. The sender system (320) can populate the payload of the authentication token of each user in the subset of users with the desired value of the “scp” claim extracted from the transformation delta. This can occur either during the initial assembly of an authentication token, or as a modification to an already-assembled authentication token.

After the authentication tokens have been assembled, and after any optional modifications to the authentication tokens have been made, the sender system (320) transmits the resulting authentication tokens (325) along with the communication (327) to the recipient systems (330) associated with the users who are the intended recipients of communication (427). In particular, each recipient system (330) receives the communication (327) and the authentication token (325) for the user associated with the recipient system (330). Each recipient system (330) can then process the received authentication token (325) to validate the communication (327). Towards this end, each recipient system (330) can include an authentication token validator (332) configured to perform operations for validating the communication (327) with the authentication token (325). The functionality of the authentication token validator (332) can be included in a client-side collaboration application executing on the recipient system, or alternatively, can be provided by software that is not part of the client-side collaboration application.

As shown, in some examples, assembly of objects (314) is performed by a recipient service (340) instead of the sender system (320). For example, a recipient service (340) can be used as an intermediary for communications to a large group of users of a collaboration platform, such as a group of users associated with an organization or other entity to whom communications are often sent in bulk. In such examples, the sender system (320) forwards the objects (314) received authorization service (310) to the recipient service (340) for assembly. The recipient service (340) can include an authentication token assembler (342), which can represent computer-executable instructions for performing operations to assembly authentication tokens; the instructions can be included in a dedicated software module, or as part of other software associated with a collaboration platform. The recipient service (340) can assemble and transmit the authentication tokens in the same manner described above for sender system (320).

### IV. EXAMPLE TOKENS AND DELTAS

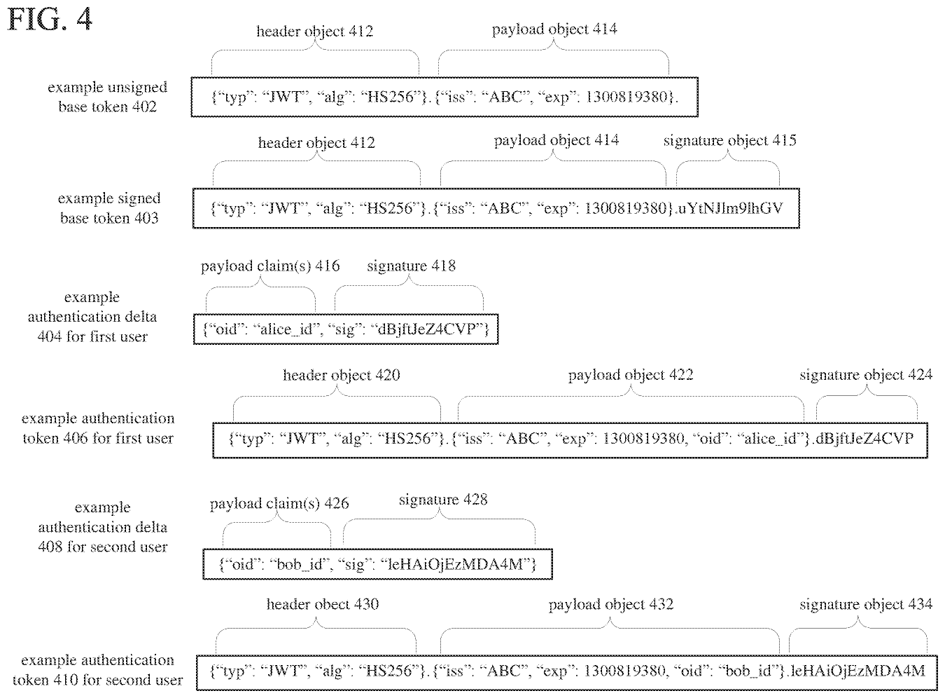

FIG. 4 shows an example unsigned base token (402), an example signed base token (403), an example authentication delta (404) for a first user (“Alice”), an example authentication token (406) for the first user, an example authentication delta (408) for a second user (“Bob”), and an example authentication token (410) for the second user. In the depicted example, the example authentication deltas (404) and (408) represent JSON objects, whereas each of the example unsigned base token (402) and example authentication tokens (406) and (410) is a JWT comprising a single string that represents a collection of JSON objects. Each JSON object comprises an unordered collection of key-value pairs. In FIG. 4, the key-value pairs are shown decoded so that their content can be understood; however, in the disclosed techniques, the key-value pairs are typically encoded using a technique such as Base64. Alternatively, other types and formats can be used for the objects and encoding without departing from the scope of this disclosure. The depicted key-value pairs are provided for the sake of example; alternatively, different key-value pairs (and different numbers of key-value pairs) can be included in the various objects, deltas, and tokens.

Example unsigned base token (402) comprises a header object (412) and a payload object (414) separated by a dot. Header object (412) comprises key-value pairs for a “typ” field and an “alg” field. The “typ” field specifies that the type of the token (i.e., the type of the token that will ultimately be assembled using data from the example unsigned base token (402)) is JWT, and the “alg” field specifies that the HS256 algorithm was used to compute the signature (i.e., the signature of the token that will ultimately be assembled using data from the example unsigned base token (402)). Payload object (414) comprises key-value pairs for an “iss” claim which specifies that the issuer of the authentication token is an authorization service referred to as ABC, and an “exp” claim whose value is a Unix timestamp representing the time at which the authentication token should no longer be accepted. As it is unsigned, the example unsigned base token (402) does not contain a signature object. In contrast, as shown, example signed base token (403) contains a signature object (415), but is otherwise identical to example unsigned base token (402).

Example authentication delta (404) for the first user is a JSON object that includes payload claim(s) (416) and a signature (418). In the depicted example, the example authentication delta (404) includes a single payload claim (416), an “oid” claim whose value (“alice_id”) whose serves as an immutable identifier of the first user. However, in other examples, a plurality of payload claims could be included in the example authentication delta (404). For example, in addition to the “oid” claim, the authentication delta (404) could include one or more other claims such as an “exp” claim. The signature (418) is an encoded string of characters generated by the authorization service ABC using the HS256 algorithm (as specified in the example unsigned base token (402)).

Example authentication token (406) for the first user is a JWT including a header object (420), a payload object (422), and a signature object (424). As described herein, the example authentication token (406) can be assembled by populating a blank authentication token template comprising an empty header object, payload object, and signature object with data from the corresponding portions of the example unsigned base token (402) and the example authentication delta (404). Accordingly, the header object (420) includes the “typ” and “alg” fields from the header object (412) of the example unsigned base token (402); the payload object (422) includes the “iss” and “exp” claims from the payload object (414) of the example unsigned base token (402) and the payload claim (416) from the example authentication delta (404); and the signature object (424) includes the signature (418) from the example authentication delta (404).

Example authentication delta (408) for the second user has the same format as example authentication delta (404) for the first user, but different values for the payload claim (426) and signature (428). In the depicted example, payload claim (426) is an “oid” claim whose value (“bob id”) serves as an immutable identifier of the second user (i.e., the user associated with the example authentication token (410) that will be assembled from the example unsigned base token (402) and the example authentication delta (408)). The signature (428) is an encoded string of characters generated by the authorization service ABC using the HS256 algorithm (as specified in the example unsigned base token (402)). As shown, the signature (428) of the example authentication delta (408) for the second user is different from the signature (418) of the example authentication delta (404) for the first user.

Similar to example authentication token (406) for the first user, example authentication token (410) for the second user is a JWT including a header object (430), a payload object (432), and a signature object (434). The header object (430) includes the “typ” and “alg” fields from the header object (412) of the example unsigned base token (402); the payload object (422) includes the “iss” and “exp” claims from the payload object (414) of the example unsigned base token (402) and the payload claim (426) from the example authentication delta (408); and the signature object (434) includes the signature (428) from the example authentication delta (408).

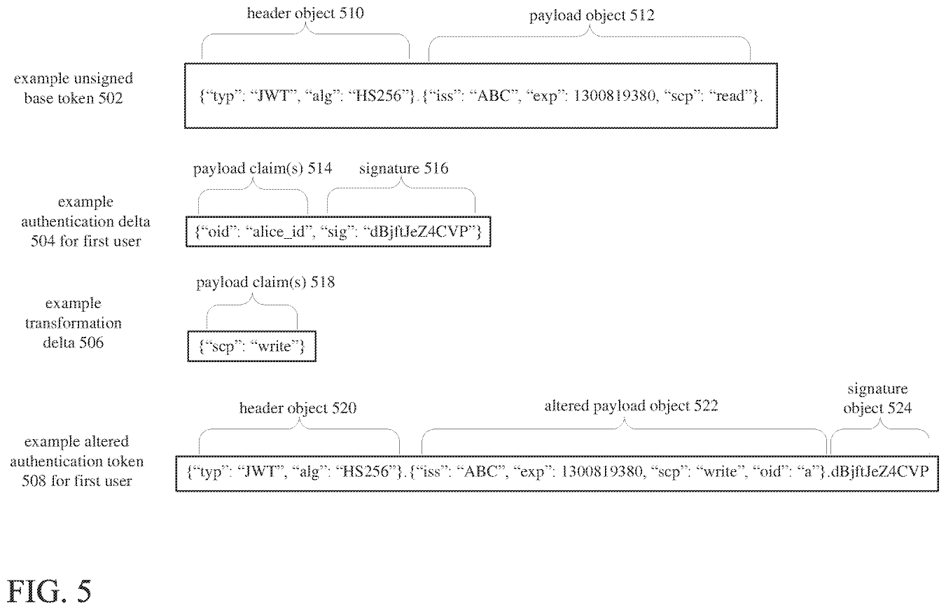

FIG. 5 is similar to FIG. 4, except that it depicts an example in which the authentication token for the first user is altered using a transformation delta. Accordingly, FIG. 5 shows an example unsigned base token (502), an example authentication delta (504) for the first user (“Alice”), an example transformation delta (506) for the first user, and an example altered authentication token (508) for the first user. While the example shown in FIG. 5 pertains to an unsigned base token (502) which does not include a signature, the base token in this example could alternatively be a signed base token (e.g., signed base token (403) of FIG. 4) which does include a signature.

Example unsigned base token (502) comprises a header object (510) and a payload object (512) separated by a dot. Similar to header object (412), header object (510) comprises key-value pairs for a “typ” field and an “alg” field. Further, similar to payload object (414), payload object (512) comprises key-value pairs for an “iss” claim and an “exp” claim. However, unlike payload object (414), payload object (512) also includes an additional key-value pair for a “scp” claim with a value of “read.” In other examples, other types or quantities of claims could be included in payload object (512).

Similar to example authentication delta (404), example authentication delta (504) for the first user is a JSON object that includes payload claim(s) (514) and a signature (516). Here again, the example authentication delta (504) includes a single payload claim (514), an “oid” claim whose value (“alice_id”) whose serves as an immutable identifier of the first user. However, in other examples, a plurality of payload claims could be included in the example authentication delta (504).

Example transformation delta (506) is a JSON object that includes payload claim(s) (518). In the depicted example, the example transformation delta (506) includes a single payload claim (518), a “scp” claim with a value of “write.” However, in other examples, a plurality of payload claims could be included in the example transformation delta (506). For example, the example transformation delta (506) could include multiple “scp” claims with different values, and/or one or more other key-value pairs including one or more key-value pairs for each of a plurality of types of claims.

Similar to example authentication token (406), example altered authentication token (508) for the first user is a JWT including a header object (520), an altered payload object (522), and a signature object (524). The example altered authentication token (508) can be assembled by populating a blank authentication token template comprising an empty header object, payload object, and signature object with data from the corresponding portions of the example unsigned base token (502) the example authentication delta (504), and the example transformation delta (506). Accordingly, the header object (520) includes the “typ” and “alg” fields from the header object (510) of the example unsigned base token (502), and the signature object (524) includes the signature (516) from the example authentication delta (504).

As for the altered payload object (522), it includes the “iss” and “exp” claims from the payload object (512) of the example unsigned base token (502), the “oid” claim from the example authentication delta (504), and the “scp” claim from the example transformation delta (506). Thus, whereas the example unsigned base token (502) included a “scp” claim with a value of “read,” the value in the “scp” claim in the example altered authentication token (508) is altered to match the value of the “scp” claim in the example transformation delta (506) and thus has a value of “write.” As described herein, the entity assembling the authentication tokens (e.g., a sender system) can opt to alter the payload of the authentication token for a selected user or users during assembly, to provide a different type of access to the communication validated by the authentication token. The alteration of the payload can be performed by replacing values of claim(s) from the base token or authentication delta with different values of the claim(s) included in one or more transformation deltas. In some examples, the transformation deltas are generated by an authorization service, whereas in other examples, another entity (e.g., the sender system) is configured to generate the transformation deltas (either solely, or in addition to the authorization service).

### V. EXAMPLE APPROACHES FOR PIECEWISE GENERATION AND TRANSMISSION OF AUTHENTICATION TOKENS

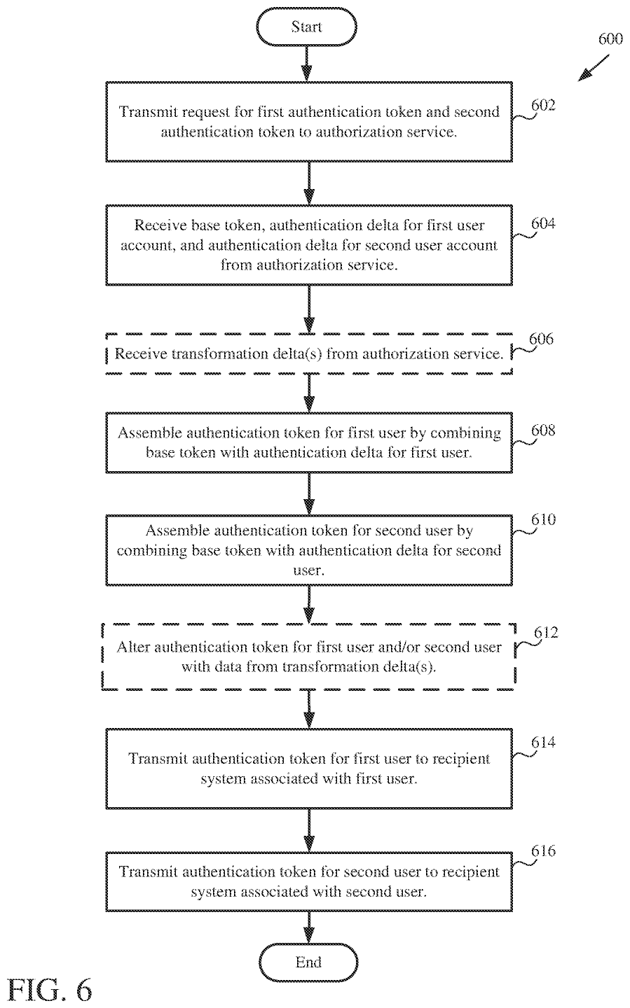

FIG. 6 shows a generalized technique (600) for obtaining, assembling, and transmitting authentication tokens in a collaboration platform. A client computing device acting as a sender system within a collaboration platform, as described with reference to FIGS. 2-3 or otherwise, can perform the technique (600).

To start, a request for a first authentication token and a second authentication token is transmitted to an authorization service (602). For example, a user acting as a sender can initiate a communication to two other participants of a collaboration platform, referred to as a first user and a second user. The initiation of the communication can trigger the sender's system to request authentication tokens for the first user and second user from an authorization service, to be transmitted along with the communication when it is sent to the first and second users.

In response to the request, a base token, an authentication delta for the first user, and an authentication delta for the second user are received (606) from the authorization service. Optionally, one or more transformation deltas are also received (606) from the authorization service.

The sender system then assembles (608) an authentication token for the first user by combining the base token with the authentication delta for the first user, and assembles (610) an authentication token for the second user by combining the base token with the authentication delta for the second user. Optionally, the sender system alters (612) one or both of the first and second authentication tokens with data from any transformation deltas received from the authorization service. Alternatively, the alteration based on the transformation delta data can occur during the assembling steps (608) and/or (610).

After assembling the authentication tokens for the first and second users and performing any desired alterations, the sender system transmits (614) the authentication token for the first user to the recipient system associated with the first user, and transmits (616) the authentication token for the second user to the recipient system associated with the second user. After this step, technique (600) ends.

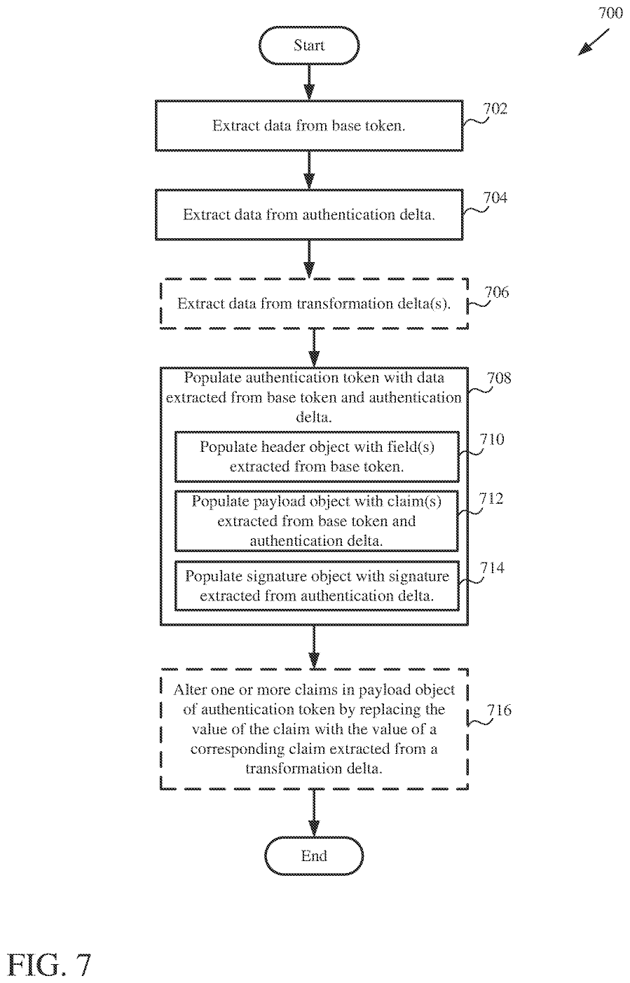

FIG. 7 shows a generalized technique (700) for assembling authentication tokens in a collaboration platform. A client computing device acting as a sender system within a collaboration platform, as described with reference to FIGS. 2-3 or otherwise, can perform the technique (700). Alternatively, a recipient service of a collaboration platform, as described with reference to FIG. 3, can perform the technique (700).

To start, data is extracted (702) from a base token (e.g., a signed or unsigned base token received from an authorization service). In addition, data is extracted (704) from an authentication delta (e.g., an authentication delta received from an authorization service). The authentication delta can be associated with a particular user of the collaboration platform who as an intended recipient of a communication initiated by the sender system. Optionally, data is also extracted (706) from one or more transformation deltas (e.g., one or more transformation deltas received from an authorization service, or generated by the sender system).

An authentication token is then populated (708) with data extracted from the base token and the authentication delta. This includes populating (710) a header object of the authentication token with one or more fields extracted from the token, populating (712) a payload object of the authentication token with one or more claims extracted from the base token and the authentication delta, and populating (714) a signature object of the authentication token with a signature extracted from the authentication delta. Optionally, one or more claims in the payload object of the authentication token can be altered (716) by replacing the value of the claim with the value of a corresponding claim extracted from a transformation delta, as described herein with reference to FIG. 5.

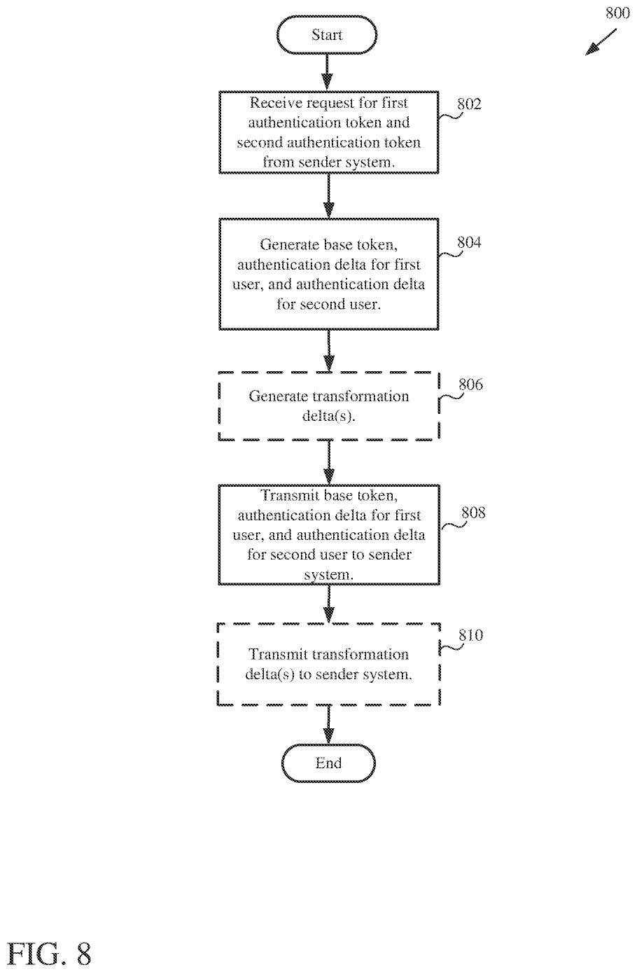

FIG. 8 shows a generalized technique (800) for generation of a base token, authentication tokens, and optional transformation delta(s) in a collaboration platform. An authorization service, as described with reference to FIGS. 2-3 or otherwise, can perform the technique (800).

First, the authorization service receives (802) a request for an authentication token for a first user and an authentication token for a second user from a sender system (e.g., from a client computing device associated with a user of a collaboration platform intending to send communication(s) to the first user and second user). The first user and second user can also be users of the collaboration platform to whom the user associated with the sender system intends to send a communication (or, multiple communications).

Responsive to the request, the authorization service generates (804) a base token, an authentication delta for the first user, and an authentication delta for the second user. Optionally, the authorization service also generates (806) one or more transformation deltas, as described herein.

Next, the authorization service transmits (808), to the sender system, the base token, the authentication delta for the first user, and the authentication delta for the second user. Optionally, the authorization service also transmits (810) any transformation delta(s) that were generated to the sender system. The sender system can then assemble these objects into authentication tokens for the first and second users, as described herein, and transmit the authentication tokens to the first and second users along with communications (e.g., messages or commands). Alternatively, the sender system can transmit the un-assembled objects to a recipient service, which in turn can assemble and transmit the authentication tokens to the intended recipients along with the communications.

### VI. EXAMPLES

The innovative features described herein include the following examples.

| | Example |
|---|---|
| A1 | In a computer system, a method comprising: |
| | transmitting a request for a first authentication token and a second |
| | authentication token; |
| | responsive to the request, receiving a base token, an authentication delta for a |
| | first user, and an authentication delta for a second user, the authentication delta for |
| | the first user comprising a first signature and a first claim representing an immutable |
| | identifier of the first user, and the authentication delta for the second user |
| | comprising a second signature and a second claim representing an immutable |
| | identifier of the second user; |
| | assembling the first authentication token by combining the base token with |
| | the authentication delta for the first user; |
| | assembling the second authentication token by combining the base token |
| | with the authentication delta for the second user; |
| | transmitting the first authentication token and a first communication to a |
| | recipient system associated with the first user; and |
| | transmitting the second authentication token and a second communication to |
| | a recipient system associated with the second user. |
| A2 | The method of A1, |
| | wherein the base token comprises a third claim, |
| | wherein combining the base token with the authentication delta for the first |
| | user comprises populating a payload object of the first authentication token with the |
| | first claim and the third claim, and |
| | wherein combining the base token with the authentication delta for the |
| | second user comprises populating a payload object of the second authentication |
| | token with the second claim and the third claim. |
| A3 | The method of Al or A2, |
| | wherein combining the base token with the authentication delta for the first |
| | user further comprises populating a signature object of the first authentication token |
| | with the first signature, and |
| | wherein combining the base token with the authentication delta for the |
| | second user further comprises populating a signature object of the second |
| | authentication token with the second signature. |
| A4 | The method of any one of A1-A3, |
| | wherein the base token further comprises a header object, the header object |
| | comprising data representing a value of a field, |
| | wherein assembling the first authentication token further comprises |
| | populating a header object of the first authentication token with the data from the |
| | header object of the base token, and |
| | wherein assembling the second authentication token further comprises |
| | populating a header object of the second authentication token with the data from the |
| | header object of the base token. |
| A5 | The method of A4, |
| | wherein the data representing the value of the field, in the header object of |
| | the first authentication token, indicates that the first authentication token is a |
| | JavaScript Object Notation (JSON) web token (JWT). |
| A6 | The method of A2, further comprising: |
| | receiving a transformation delta comprising a fourth claim, the fourth claim |
| | having a same type as the third claim and a different value than the third claim; |
| | altering the first authentication token by replacing the value of the third claim |
| | with the value of the fourth claim; and |
| | transmitting the altered first authentication token to the recipient system |
| | associated with the first user. |
| A7 | The method of A6, wherein the type of the third claim and the fourth claim is |
| | scope. |
| A8 | The method of any one of A1-A7, further comprising: |
| | transmitting the base token and respective authentication deltas for a plurality |
| | of users to a recipient service for assembly, wherein the recipient service is |
| | associated with the plurality of users, and wherein the recipient service performs the |
| | assembling the first authentication token, the assembling the second authentication |
| | token, the transmitting the first authentication token, and the transmitting the second |
| | authentication token. |
| A9 | The method of any one of A1-A8, further comprising: |
| | transmitting the first authentication token to a plurality of additional recipient |
| | systems associated with the first user. |
| A10 | The method of A9, wherein the plurality of additional recipient systems |
| | comprise one or more of a chat system and a meeting system. |
| A11 | The method of any one of A1-A10, wherein: |
| | the base token is an unsigned base token which does not include a signature; |
| | or |
| | the base token is a signed base token which includes a signature. |
| B1 | A computer system comprising a processing system and memory, wherein |
| | the computer system is configured to perform operations for piecewise generation |
| | and transmission of authentication tokens, the operations comprising: |
| | receiving, from a sender system, a request for a first authentication token and |
| | a second authentication token; |
| | generating a base token; |
| | generating an authentication delta for a first user, the authentication delta for |
| | the first user comprising a first signature and a first claim representing an immutable |
| | identifier of the first user; |
| | generating an authentication delta for a second user, the authentication delta |
| | for the second user comprising a second signature and a second claim representing |
| | an immutable identifier of the second user; and |
| | transmitting the base token, the authentication delta for the first user, and the |
| | authentication delta for the second user to the sender system. |
| B2 | The computer system of B1, wherein the first signature comprises a first |
| | string of characters, and wherein the second signature comprises a second string of |
| | characters different than the first string of characters. |
| B3 | The computer system of B1 or B2, wherein the first and second |
| | authentication tokens are JavaScript Object Notation (JSON) web tokens (JWTs). |
| B4 | The computer system of any one of B1-B3, wherein the base token |
| | comprises a type field, an algorithm field, and a third claim having a type and a |
| | value. |
| B5 | The computer system of B4, wherein the operations further comprise: |
| | generating a transformation delta comprising a fourth claim, the fourth claim |
| | having a same type as the third claim and a different value than the third claim; and |
| | transmitting the transformation delta to the sender system. |
| B6 | The computer system of B4 or B5, |
| | wherein the first and second authentication tokens are compressed |
| | authentication tokens, |
| | wherein generating the base token comprises generating an encoded string of |
| | characters representing the type field, the algorithm field, and the third claim, |
| | wherein generating the authentication delta for the first user comprises |
| | generating an encoded string of characters representing the first claim, and |
| | wherein generating the authentication delta for the second user comprises |
| | generating an encoded string of characters representing the second claim. |
| B7 | The computer system of B6, wherein the encoded strings of characters are |
| | Base64 encoded strings. |
| B8 | The computer system of any one of B1-B7, wherein the computer system |
| | implements an authorization service for a collaboration platform, and wherein the |
| | sender system sends communications to a recipient system associated with the first |
| | user and a recipient system associated with the second user via the collaboration |
| | platform. |
| B9 | The method of any one of B1-B8, wherein: |
| | the base token is an unsigned base token which does not include a signature; |
| | or |
| | the base token is a signed base token which includes a signature. |
| C1 | A non-transitory computer-readable medium having stored thereon |
| | computer-executable instructions for causing a computer system, when programmed |
| | thereby, to perform operations for piecewise generation and transmission of |
| | authentication tokens for a collaboration platform, the operations comprising: |
| | with an authorization service: |
| | receiving, from a sender system, a request for a first authentication |
| | token and a second authentication token; |
| | generating an encoded string of characters representing a base token; |
| | generating an authentication delta for a first user, the authentication |
| | delta for the first user comprising a first signature and a first claim |
| | representing an immutable identifier of the first user, the first signature |
| | comprising a first string of characters; |
| | generating an authentication delta for a second user, the |
| | authentication delta for the second user comprising a second signature and a |
| | second claim representing an immutable identifier of the second user, the |
| | second signature comprising a second string of characters different than the |
| | first string of characters; and |
| | transmitting the base token, the authentication delta for the first user, |
| | and the authentication delta for the second user to the sender system; and |
| | with the sender system: |
| | receiving, from the authorization service, the base token, the |
| | authentication delta for the first user, and the authentication delta for |
| | the second user; |
| | assembling the first authentication token by combining the |
| | base token with the authentication delta for the first user; |
| | assembling the second authentication token by combining the |
| | base token with the authentication delta for the second user; |
| | transmitting the first authentication token to a recipient |
| | system associated with the first user; and |
| | transmitting the second authentication token to a recipient |
| | system associated with the second user. |
| C2 | The computer-readable medium of C1, |
| | wherein the base token comprises a third claim having a type and a value, |
| | and |
| | wherein the operations further comprise, |
| | with the authorization service: |
| | generating a transformation delta comprising a fourth claim, |
| | the fourth claim having a same type as the third claim and a different |
| | value than the third claim; and |
| | transmitting the transformation delta to the sender system; and |
| | with the sender system: |
| | receiving the transformation delta from the authorization |
| | service; |
| | altering the first authentication token by replacing the value of |
| | the third claim with the value of the fourth claim; and |
| | transmitting the altered first authentication token to the |
| | recipient system associated with the first user. |

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

What is claimed is:

1. In a computer system, a method comprising:
transmitting a request for a first authentication token and a second authentication token;
responsive to the request, receiving a base token, an authentication delta for a first user, and an authentication delta for a second user, the authentication delta for the first user comprising a first signature and a first claim representing an immutable identifier of the first user, and the authentication delta for the second user comprising a second signature and a second claim representing an immutable identifier of the second user;
assembling the first authentication token by combining the base token with the authentication delta for the first user;
assembling the second authentication token by combining the base token with the authentication delta for the second user;
transmitting the first authentication token and a first communication to a recipient system associated with the first user; and
transmitting the second authentication token and a second communication to a recipient system associated with the second user.

2. The method of claim 1,
wherein the base token comprises a third claim,
wherein combining the base token with the authentication delta for the first user comprises populating a payload object of the first authentication token with the first claim and the third claim, and
wherein combining the base token with the authentication delta for the second user comprises populating a payload object of the second authentication token with the second claim and the third claim.

3. The method of claim 2,
wherein combining the base token with the authentication delta for the first user further comprises populating a signature object of the first authentication token with the first signature, and
wherein combining the base token with the authentication delta for the second user further comprises populating a signature object of the second authentication token with the second signature.

4. The method of claim 3,
wherein the base token further comprises a header object, the header object comprising data representing a value of a field,
wherein assembling the first authentication token further comprises populating a header object of the first authentication token with the data from the header object of the base token, and
wherein assembling the second authentication token further comprises populating a header object of the second authentication token with the data from the header object of the base token.

5. The method of claim 4,
wherein the data representing the value of the field, in the header object of the first authentication token, indicates that the first authentication token is a JavaScript Object Notation (JSON) web token (JWT).

6. The method of claim 2, further comprising:
receiving a transformation delta comprising a fourth claim, the fourth claim having a same type as the third claim and a different value than the third claim;
altering the first authentication token by replacing the value of the third claim with the value of the fourth claim; and
transmitting the altered first authentication token to the recipient system associated with the first user.

7. The method of claim 6,
wherein the type of the third claim and the fourth claim is scope.

8. The method of claim 1, further comprising:
transmitting the base token and respective authentication deltas for a plurality of users to a recipient service for assembly, wherein the recipient service is associated with the plurality of users, and wherein the recipient service performs the assembling the first authentication token, the assembling the second authentication token, the transmitting the first authentication token, and the transmitting the second authentication token.

9. The method of claim 1, further comprising:
transmitting the first authentication token to a plurality of additional recipient systems associated with the first user.

10. The method of claim 9, wherein the plurality of additional recipient systems comprise one or more of a chat system and a meeting system.

11. A computer system comprising a processing system and memory, wherein the computer system is configured to perform operations for piecewise generation and transmission of authentication tokens, the operations comprising:
receiving, from a sender system, a request for a first authentication token and a second authentication token;
generating a base token;
generating an authentication delta for a first user, the authentication delta for the first user comprising a first signature and a first claim representing an immutable identifier of the first user;
generating an authentication delta for a second user, the authentication delta for the second user comprising a second signature and a second claim representing an immutable identifier of the second user; and
transmitting the base token, the authentication delta for the first user, and the authentication delta for the second user to the sender system.

12. The computer system of claim 11, wherein the first signature comprises a first string of characters, and wherein the second signature comprises a second string of characters different than the first string of characters.

13. The computer system of claim 11, wherein the base token comprises a type field, an algorithm field, and a third claim having a type and a value.

14. The computer system of claim 13, wherein the operations further comprise:
generating a transformation delta comprising a fourth claim, the fourth claim having a same type as the third claim and a different value than the third claim; and
transmitting the transformation delta to the sender system.

15. The computer system of claim 13,
wherein the first and second authentication tokens are compressed authentication tokens,
wherein generating the base token comprises generating an encoded string of characters representing the type field, the algorithm field, and the third claim,
wherein generating the authentication delta for the first user comprises generating an encoded string of characters representing the first claim, and
wherein generating the authentication delta for the second user comprises generating an encoded string of characters representing the second claim.

16. The computer system of claim 11, wherein the base token is an unsigned base token which does not include a signature.

17. The computer system of claim 11, wherein the base token is a signed base token which includes a signature.

18. The computer system of claim 11, wherein the computer system implements an authorization service for a collaboration platform, and wherein the sender system sends communications to a recipient system associated with the first user and a recipient system associated with the second user via the collaboration platform.

19. A non-transitory computer-readable medium having stored thereon computer-executable instructions for causing a computer system, when programmed thereby, to perform operations for piecewise generation and transmission of authentication tokens for a collaboration platform, the operations comprising:
with an authorization service:
receiving, from a sender system, a request for a first authentication token and a second authentication token;
generating an encoded string of characters representing a base token;
generating an authentication delta for a first user, the authentication delta for the first user comprising a first signature and a first claim representing an immutable identifier of the first user, the first signature comprising a first string of characters;
generating an authentication delta for a second user, the authentication delta for the second user comprising a second signature and a second claim representing an immutable identifier of the second user, the second signature comprising a second string of characters different than the first string of characters; and
transmitting the base token, the authentication delta for the first user, and the authentication delta for the second user to the sender system; and
with the sender system:
receiving, from the authorization service, the base token, the authentication delta for the first user, and the authentication delta for the second user;
assembling the first authentication token by combining the base token with the authentication delta for the first user;
assembling the second authentication token by combining the base token with the authentication delta for the second user;
transmitting the first authentication token to a recipient system associated with the first user; and
transmitting the second authentication token to a recipient system associated with the second user.

20. The computer-readable medium of claim 19,
wherein the base token comprises a third claim having a type and a value, and
wherein the operations further comprise,
with the authorization service:
generating a transformation delta comprising a fourth claim, the fourth claim having a same type as the third claim and a different value than the third claim; and
transmitting the transformation delta to the sender system; and
with the sender system:
receiving the transformation delta from the authorization service;
altering the first authentication token by replacing the value of the third claim with the value of the fourth claim; and
transmitting the altered first authentication token to the recipient system associated with the first user.
